(19) United States
(12) Patent Application Publication
(10) Pub. No.: US 2009/0001301 A1
(43) Pub. Date: Jan. 1, 2009

(54) Blow-off valve

(76) Inventor: Soeren Boegh Andersen, Helsingoer (DK)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/214,973

(22) Filed: Jun. 24, 2008

(30) Foreign Application Priority Data
Jun. 26, 2007 (EP) 07012513.3

(51) Int. Cl. F16K 31/124

(52) U.S. Cl. 251/28; 251/62

(57) ABSTRACT

Commonly blow-off valves are very expensive devices due to the high reliability requirements and the necessity of a high volume flow rate to obtain an immediate drop of pressure in the system. In order to reduce costs and obtain a simple and reliable system, it is proposed to use an actuation vessel with a piston within, which is connected rigidly to the free piston and to operate the piston by applying the system pressure on one site of the piston to keep the Blow-off-valve closed and to open the blow-off-valve by connecting the vessel with a lower pressure, preferably atmospheric pressure.

### CROSS REFERENCE TO RELATED APPLICATIONS

This application claims the benefits of European application No. 0702513.3 filed Jun. 26, 2007 and is incorporated by reference herein in its entirety.

### FIELD OF INVENTION

The present invention relates to a blow-off valve with a pressure port, which pressure port is preferably connected to a discharge pipe of a compressor, which blow-off valve comprises a blow-off port, a free piston and an actuator module, wherein the free piston is moved by the actuator module to block or to passage a flow from the pressure port through the blow-off port.

### BACKGROUND OF THE INVENTION

Blow-off valves are usually used in connection with compressors to avoid certain operating conditions, which might be dangerous or damage the machine. In most cases the blow-off valves open a blow-off port to release the fluid under pressure in the surrounding atmosphere, when operating conditions are risky. Risky operating conditions might be over-pressure according to the criteria of standard discharge pipe rules or might be the reaching of surge-conditions, under which a compressor might get damaged.

Typically a blow off valve of the above type consists of a butterfly valve that is actuated by a 90° turn electric or pneumatic actuator.

Since a blow-off valve is a critical part for the safety of the machine it must be highly reliable. Besides, a blow-off valve should be capable to induce a pressure drop within nearly zero amount of time to avoid a longer duration of dangerous conditions. Therefore, blow-off valves are designed preferably simple and robust. Since the blow-off valve should be capable to induce a pressure drop immediately a blow-off valve must be capable for a very high flow rate in the opening position and therefore it is usually big in size. The fast actuation of a big free piston in the body of the valve needs a very powerful actuation of the valve, which also must be extremely reliable. All theses requirements of extreme operating conditions lead to expensiveness especially of the actuation of the blow-off valve.

It is commonly known to operate the blow-off valve by an actuator module, in which a membrane is exposed on the one side to the system pressure, which membrane is mechanically connected to the free piston of the blow-off valve, thus exceeding a certain system pressure leads to a movement of the membrane, which pushes the free piston in an open position, so that the protected discharge pipe is connected to the blow-off port of the valve and reduces internal pressure. However, such an arrangement incorporating a membrane, which must be made of an elastic material, has only limited life duration, even if the blow-off valve is rarely operated. The strictly limited life time of an elastic membrane reduces the reliability respectively increases the maintenance effort costly.

One membrane operated valve is known for instance from the patent DE 30 10 158 C2.

Another prior proposal documented in U.S. Pat. No. 4,679,982 provides a ring shaped opening which can be closed by an also ring shaped closing element, which is actuated by a mechanical device involving threaded rods to be turned by hand. Indeed this arrangement seems to be powerful enough to open and close the blow-off opening but is on the other hand not fast enough to guarantee the fulfillment of the discharge pipe rules under each operating conditions of modern compressors. Especially the confidence in the attention and correct reaction of the operating personnel is not acceptable.

### SUMMARY OF INVENTION

It is therefore one object of the invention to provide a blow-off valve which is highly reliable in operation inexpensive to manufacture, simple in structure and capable to fulfill operational requirements especially to avoid dangerous operating conditions.

The above object is solved according to the present invention by a blow-off valve of the above mentioned kind, which comprises a piston, which is mechanically connected to the free piston, an vessel which is closed up by the piston a control valve which has a first port, a second port and a third port, a pressure line connecting the discharge pipe with the actuator module vessel, wherein the control valve is positioned in the pressure line either connecting the vessel to the pressure line or to a pressure which is lower than the pressure in the discharge pipe, wherein the piston has a bigger surface exposed to a part of the vessel, which is connected to the pressure line than the surface of the free piston being exposed to the pressure of the discharge pipe, so that a connection of the vessel with the discharge pipe through the pressure line established by the control valve causing to move the blow-off valve enclosing position and a free pistononnection of the vessel and the discharge pipe by operation of the control valve causes the blow-off valve to move in an opening position.

By using a rigid piston instead of a membrane to actuate the free piston of the blow-off valve a very robust and simple arrangement is obtained. The piston nearly needs no maintenance and even if a seal at the piston edge is worn out the blow-off valve is still capable to operate properly. Since the system pressure is used to build up the moving force for the free piston to open respectively close the blow-off port of the blow-off valves a big actuating drive is not needed and costs are saved. Moreover, this concept simplifies the construction significantly and therefore the reliability is increased.

Preferably the blow-off port of the valve is connected to a silencer to reduce the noise emission.

Advantageously the silencer can be shaped like a bowl, which at least encloses the free piston, the blow-off port and the valve body itself. The blow-off valve becomes thus a very compact unit, which comprises a housing which's function is also to reduce the noise emission.

Highest constructional flexibility can be obtained by driving the control valve electrically that it can easily be connected to any standard control unit.

A very reliable and simple arrangement is obtained, when the piston is rigidly connected with the free piston by a rod.

At least for air compressors a most simple solution is obtained, when the blow-off port respectively the silencer blows the excessive compressed fluid into the atmosphere. Also the part of the actuator module vessel, which is not connectable to the discharge pipe due to the piston in-between can be connected to atmosphere pressure. Next to that, the ulterior site of the free piston, which is not exposed to the discharge pipe, should be exposed to atmospheric pressure. To obtain a reasonable velocity of the valve movement respectively a damping of the opening and closing the connection of the ulterior side of the free piston respectively of the side of the piston, which is not exposed to the pressure of the discharge pipe, can be designed with a defined size, designed in such a manner that the fluid flowing through the connection displaced by the piston respectively the free piston slows down the movement between the opening position and the closing position of the blow-off valve. This measure can also avoid fluttering between opening and closing positions.

### BRIEF DESCRIPTION OF THE DRAWINGS

The above mentioned attributes and other features and advantages of this invention and the manner of attaining them, will become more apparent and the invention itself will be better understood by reference to the following description of embodiments including the best currently attainable mode of the invention taken in conjunction with the accompanying drawings, wherein:

FIG. 1 shows a schematic sectional view through the blow-off valve according to the invention.

### DETAILED DESCRIPTION OF INVENTION

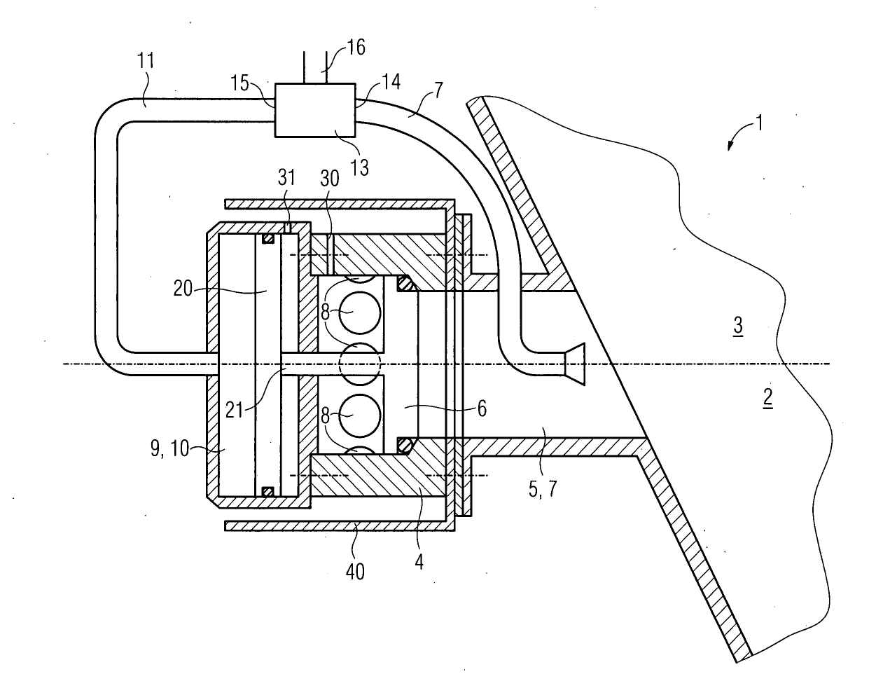

FIG. 1 shows a blow-off valve 1, which is connected to a discharge pipe 2 of a compressor 3 by an inlet port 5, which connection is only indicated in the drawing. The blow-off valve 1 comprises generally a valve body 4, containing a free piston 6, which blocks or releases the flow from an inlet port 7, which is connected to the discharge pipe 2 of the compressor 3 and a blow-off port 8. The blow-off valve 1 furthermore comprises an actuator module 10, which moves the free piston 6 between opened and closed positions.

The actuator module 9 includes a vessel 10 a pressure line 11 connecting the vessel 10 and the discharge pipe 2, in which a control valve 13 is provided. The control valve 13 has a first port 14 a second port 15 and a third port 16, wherein the first port 14 is connected by a pressure conduct 7 to the discharge pipe 2, the second port 15 is connected to the vessel 10 and the third port 16 is connected to atmospheric pressure. The control valve 13 either establish the connection between the first port 14 and the second port 15 or between the second port 15 and the third port 16 connecting to the atmosphere.

A piston 20 is provided in the vessel 10, which divides the vessel 10 into a room, in which the pressure of the pressure line 11 establishes and a room, which has atmospheric pressure due to a channel 31 connecting this part of the vessel 10 with the third port 16 respectively atmospheric pressure. The piston 20 is rigidly connected with the free piston 6 by a rod 21 so that the free piston 6 makes the same linear movement as the piston 20.

As long as the control valve 13 establishes a connection between the first port 14 and the second port 15 without opening the third port 16 the piston 20 is exposed on the one side to the same pressure as in the discharge pipe 2 and since the exposed surface of the piston 20 is bigger than the surface of the free piston 6 facing the discharge pipe 2 the blow-off-valve 1 remains in the closed position. When the control valve 13 connects the second port 15 to the third port 16 the pressure in the vessel 10 drops and due to the higher pressure on the surface of the free piston 6 facing the discharge pipe 2 the blow-off valve 1 moves in the open position and the discharge pipe 2 is connected with the blow-off port 8.

The velocity of this movement into the open position depends on the size of the channels 30, 31 connecting the respectively ulterior sides of the piston 20 respectively the free piston 6 with the atmosphere.

The whole blow-off valve 1 is enclosed by a silencer 40 having the shape of a bowl, in which the blow-off port 8 of the valve is ending in. Therefore, the bowl-shaped silencer 40 functions also as housing for the blow-off-valve 1.

While the present invention has been described as having a preferred design respectively a best mode, it can be further modified within the spirit and the scope of this free pistonlosure. This application is therefore intended to cover any variations, uses and adoptions of the invention using its general principals. Further, this application is intended to cover such departures from the present free pistonlosure as come with a known or customer practice in the art to which this invention pertains.

1.-6. (canceled)

7. A blow-off valve with an inlet port connected to a discharge pipe of a compressor where a free piston is moved by an actuator module to block or to passage a flow from the inlet port through the blow-off port, the blow-off valve comprising:
a piston mechanically and rigidly connected to the free piston;
an actuation vessel that is closed up by the piston;
a control valve having a first port, a second port and a third port;
a pressure line connecting the discharge pipe to the actuation vessel,
wherein:
the control valve is positioned in the pressure line and either connects the vessel to the pressure line or connects the vessel to a pressure, which is lower than the pressure in the discharge pipe,
the piston has a bigger surface exposed to the part of the vessel, which is connected to the pressure line than the surface of the free piston is exposed to the pressure of the discharge pipe,
so that the connection of the vessel with the discharge pipe through the pressure line established by the control valve causes the blow-off valve to move in a closing position and a free pistononnection of the actuation vessel and the discharge pipe by operation of the control valve causes the blow-off valve to move in an opening position.

8. The blow-off-valve according to claim 7, wherein the blow-off valve comprises a silencer, to which the blow-off port is connected, when the blow-off valve is in an opening position.

9. Blow-off-valve according to claim 8, wherein the silencer has the shape of a bow, which at least encloses the free piston, the blow-off port and a valve body.

10. The blow-off-valve according to claim 9, wherein the control valve is electrically driven.

11. The blow-off-valve according to claim 10, wherein the piston is rigidly connected with the free piston by a rod.

12. The blow-off-valve according to claim 11, wherein the part of the vessel, not connectable to the discharge pipe due to the piston being in between, is at atmospheric pressure.
